(19) United States
(12) Patent Application Publication
(10) Pub. No.: US 2013/0049346 A1
(43) Pub. Date: Feb. 28, 2013

(54) BOOK BOUND WITH A HANDLE

(71) Applicant: William Derraugh, Weston, CT (US)

(72) Inventor: William Derraugh, Weston, CT (US)

(21) Appl. No.: 13/218,375

(22) Filed: Aug. 25, 2011

(51) Int. Cl. B42D 17/00

(52) U.S. Cl. 281/43

(57) ABSTRACT

Described is a children's book that includes a handle that is bound with the book. The book includes at least two leaves, such as a front cover and a rear cover, with a cord that is attached with the two leaves. The cord passes through a handle mechanism to bind the handle mechanism with the binding of the book, thereby allowing a child to carry the children's book through us of the handle mechanism.

### BACKGROUND OF THE INVENTION

(1) Field of Invention

The present invention relates to a book and, more particularly, to a book with a handle mechanism that is integrally connected with the book's binding.

(2) Description of Related Art

Books have long been used as tools to teach and educate children. Historically, books were made of paper and bound using a traditional paper binding technique. While functional for text and illustrations, traditional paper books tear easily and do not hold up to the demands of children. In many cases, young children flipping through a book do not have an appreciation for the delicacy of paper and inadvertently tear the pages from a paper book.

To increase the durability and interactive features of children's books, recent innovations have led to books formed of wood. Wood books are considerably more durable than their paper counterparts and allow for additional features to be added to the book, such as puzzle pieces, etc.

While more durable than traditional paper books, wood books are also considerably more bulky and heavy than traditional children's books. Thus, it is desirable to have a book that allows a young child to easily carry the book.

As such, there is a continuing need for a book (such as a wood book) with a handle mechanism that is integrally connected with the book's binding.

### SUMMARY OF INVENTION

The present invention relates to a children's book. The book includes at least two leaves and a flexible device attached with the two leaves. A handle mechanism is attached with the flexible device, thereby allowing a child to carry the children's book through use of the handle mechanism.

In another aspect, the flexible device is a cord.

In yet another aspect, each of the leaves has holes formed therethrough, with the cord passing through the holes to bind the leaves together and affix the handle mechanism with the book. The two leaves are a front cover and a rear cover, and further comprising a page positioned between the front cover and rear cover. A hole is formed through the pages such that the cord passes through the front cover, page, and rear cover to bind the book. The cord is threaded through each of the front cover, page, and rear cover to form a front cord loop and a rear cord loop. The cord is further threaded through the handle mechanism to attach the front cord loop with the rear cord loop.

In another aspect, the leaves are made of a material selected from a group consisting of wood, paperboard, and foam, or any combination thereof.

In yet another aspect, each leaf is made of two halves, with a sheet material that is affixed between the two halves of each leaf to bind the leaves together. The two leaves are a front cover and a rear cover, and further comprising a page positioned between the front cover and rear cover, such that each of the front cover, rear cover, and page are made of two halves, with a sheet material that is affixed between the two halves of each leaf to bind the front cover to the page and the rear cover to the page. Additionally, an outer sheet material is affixed between the two halves of each of the front cover and rear cover. The outer sheet material includes an inner surface, with the cord glued to an inner surface of the outer sheet material to affix the handle mechanism with the binding of the book.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a book with a handle mechanism according to the present invention;

FIG. 2 is an illustration of a book with a handle mechanism according to the present invention;

FIG. 3A is an illustration of a book with a handle mechanism according to the present invention;

FIG. 3B is an illustration depicting the book and cord with and without a handle mechanism;

FIG. 3C is an illustration depicting the book and cord with and without a handle mechanism;

FIG. 4 is an illustration of a book with a handle mechanism according to the present invention;

FIG. 5 is an illustration depicting two adjacent leaves being attached with one another;

FIG. 6 is an illustration depicting formation of a book with a handle mechanism according to the present invention;

FIG. 7 is an illustration of a book with a handle mechanism according to the present invention;

FIG. 8 is an illustration of a book with a handle mechanism according to the present invention;

FIG. 9 is an illustration of a book with a handle mechanism according to the present invention; and

FIG. 10 is an illustration of a book being attached with a display board.

### DETAILED DESCRIPTION

The present invention relates to a book and, more particularly, to a book with a handle mechanism that is integrally connected with the book's binding. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction.

Instead, they are used to reflect relative locations and/or directions between various portions of an object.

(1) Description

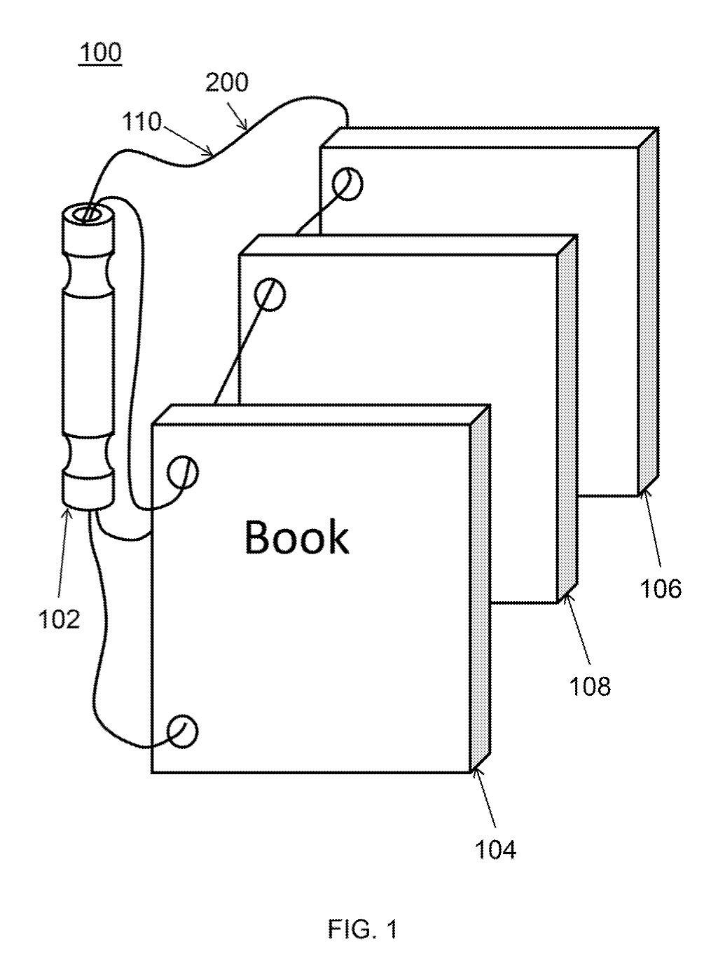

As shown in FIG. 1, the present invention relates to a book 100 with a handle mechanism 102 that is integrally connected with the book's binding. The book 100 includes a front cover 104, a rear cover 106, and a page 108 therebetween. The front cover 104, rear cover 106 and page(s) 108 can collectively be referred to as “leaves” or individually as a “leaf”. Although FIG. 1 illustrates the book 100 as having a single page 108, it should be understood that the present invention is not limited thereto as the book 100 can be formed to include any number of pages as desired or, in its simplest aspect, only two leaves (such as only a front cover and rear cover, with no pages therebetween) or any combination thereof. Thus, minimally, the present invention requires at least two leaves, with those two leaves operating as the front cover 104 and rear cover 106.

Each of the front cover 104, rear cover 106, and pages 108 can be formed of any suitable material, such as wood, paperboard, foam, or any combination thereof. In a desired aspect, each of the front cover 104, rear cover 106, and pages 108 are formed of wood. As another non-limiting example, the front cover 104 and rear cover 106 are made of wood while the pages 108 are made of paperboard.

It should be noted that all of the leaves (i.e., front cover 104, rear cover 106, and page(s) 108), or some of the leaves (such as only the front 104 and rear cover 106), or none of the leaves may be made of wood. Importantly, the present invention includes a handle mechanism 102 that is attached to any of the leaves by a flexible device (as described in further detail below).

To serve as a book, each of the front cover 104, rear cover 106, and pages 108 can include various text and/or images. For example, text and/or images can be painted and/or printed on the front cover 104, rear cover 106, and/or pages 108. As another non-limiting example, text and/or images can be applied to another medium that is adhered to any of the front cover 104, rear cover 106, and/or pages 108. For example, the text and/or images can be applied to a sticker or another sheet of material that is glued or otherwise adhered to any of the front cover 104, rear cover 106 and/or pages 108.

The front cover 104, rear cover 106, and pages 108 are bound through a binding 110 such that the handle mechanism 102 is integrally connected with the book's binding 110. Thus, the present invention includes various binding techniques that allow for the handle mechanism 102 to be connected with the binding 110.

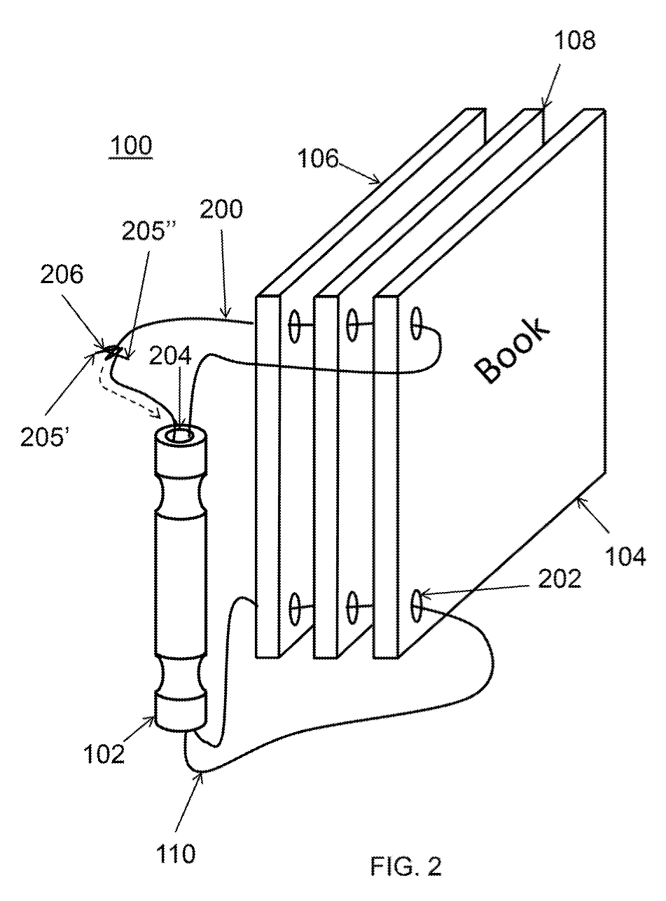

For example and as shown in FIG. 2, the binding 110 includes a flexible device that is passed through holes 202 formed in each of the front cover 104, rear cover 106, and pages 108. The flexible device is any suitable mechanism or device that can be manipulated to attach with a handle mechanism 102 and with book, non-limiting examples of which include flexible straps and a cord 200. For example, the cord 200 is formed of any suitably flexible material, non-limiting examples of which include leather, nylon, string, rope, etc. It should be understood that the present invention can use two separate cords to bind the book to the handle and, as such, is not limited to having a single long cord. As depicted, the cord 200 passes through the holes 202 and also through a handle hole 204 that is formed through the handle mechanism 102. Thus, the handle mechanism 102 in this aspect is a rod-like item that includes a handle hole 204 therethrough. The handle mechanism 102 is formed of any suitable material, non-limiting examples of which include wood and plastic. Further, the handle mechanism 102 is formed in any suitable shape, a non-limiting example of which includes being generally cylindrically shaped.

The cord 200 can be attached with the book 200 in any suitable manner. As a non-limiting example, to attach the cord 200 with the book 100, the cord 200 can be passed through the holes 202 and the handle hole 204, with the cord 200 thereafter attached with itself. For example, the two opposing ends 205′ and 205″ of the cord 200 can be knotted together (to form a knot 206) so that the cord 200 essentially forms a loop. Alternatively, the ends 205′ and 205″ of the cord 200 can be glued or stitched together, or otherwise attached with one another using any suitable connection technique. The knot 206 or other connection point can then be positioned within the handle hole 204 to secure and obscure the connection from an end user. Importantly, the cord 200 binds the handle mechanism 102 to the leaf.

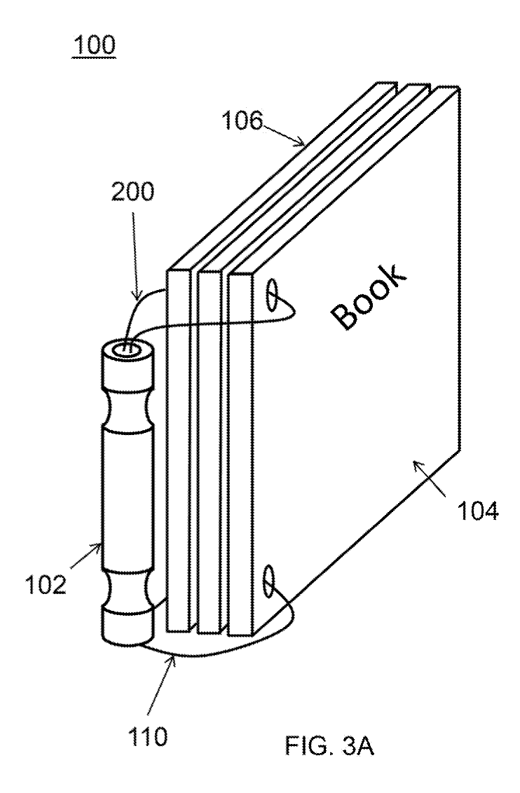

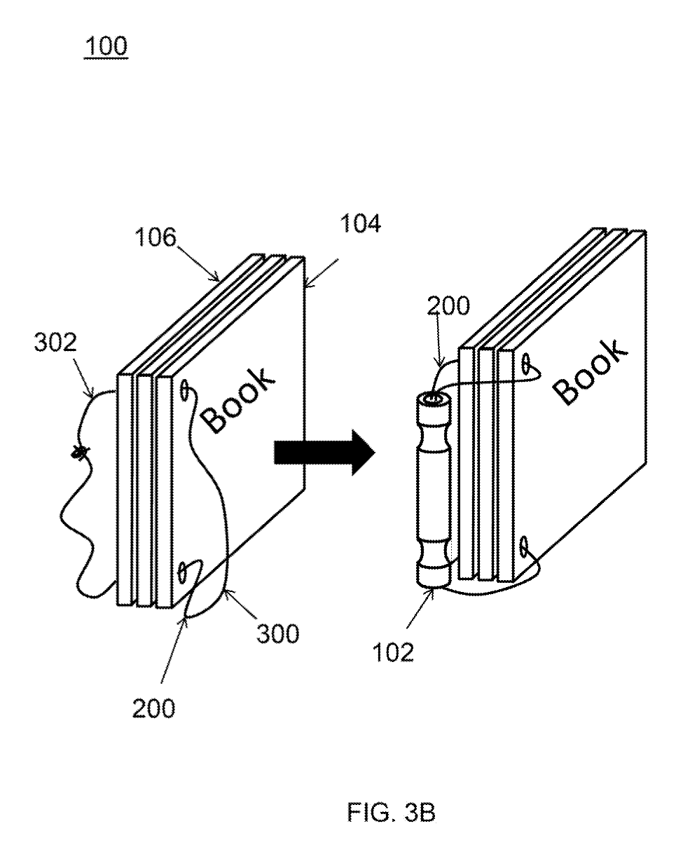

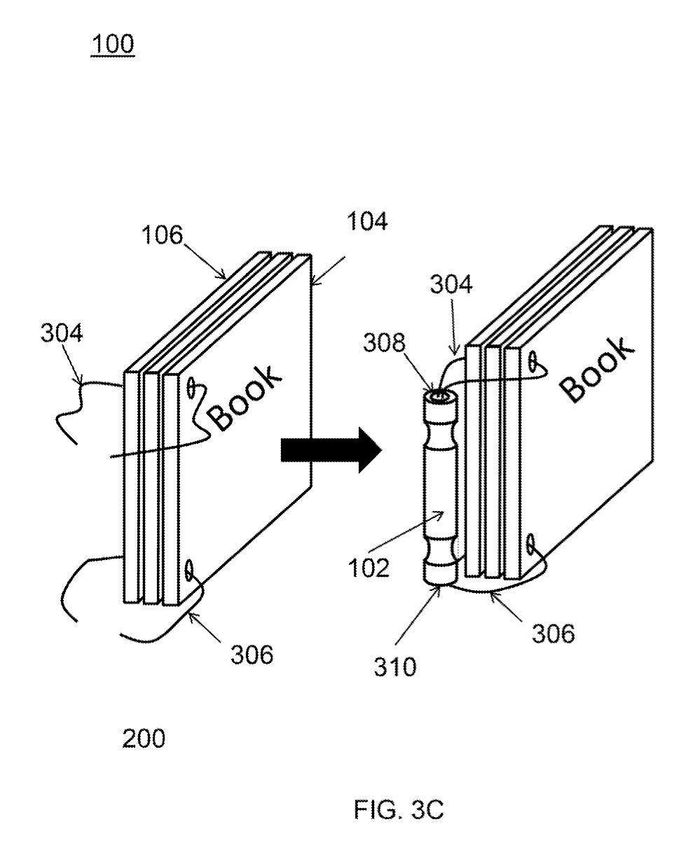

For further understanding, FIG. 3A depicts book 100 according to the present invention. As shown, the book 100 includes a handle mechanism 102 that is integrally connected with the binding 110. The handle mechanism 102 allows a small child to easily hold and carry the book 100.

As can be appreciated, the handle mechanism 102 serves to bind the book 100 and operate as a handle. For further illustration, FIG. 3B depicts the book 100 and cord 200 with and without a handle mechanism 102. As depicted on the left-side of FIG. 3B, the cord 200 emerges separately from the front cover 104 and rear cover 106 to form a front cord loop 300 and a rear cord loop 302. In threading the cord 200 through the book 100, the cord 200 is passed through the handle mechanism 102 to effectively attach the front cord loop 300 with the rear cord loop 302, as depicted in the right-side of FIG. 3B.

Another aspect is depicted in FIG. 3C, which illustrates two cords being used to bind the book with the handle mechanism 102. As a non-limiting example, this aspect includes a top cord 304 and a bottom cord 306. Each of the top cord 304 and bottom cord 306 pass through the front cover 104 and rear cover 106 (and any intervening leaves or pages). Instead of being threaded through the handle mechanism 102, each of the top cord 304 and bottom cord 306 are affixed with the handle mechanism 102. For example, the top cord 304 is affixed to the handle mechanism 102 at a top connection point 308, while the bottom cord 306 is affixed to the handle mechanism 102 at a bottom connection point 310. In either event, the cords are affixed with the handle mechanism 102 using any suitable connection technique, non-limiting examples of which include glue, staples, etc. Further, although the handle mechanism 102 can be hollow, it is not limited thereto as it can be formed to be solid (which works well with the aspect depicted in FIG. 3C).

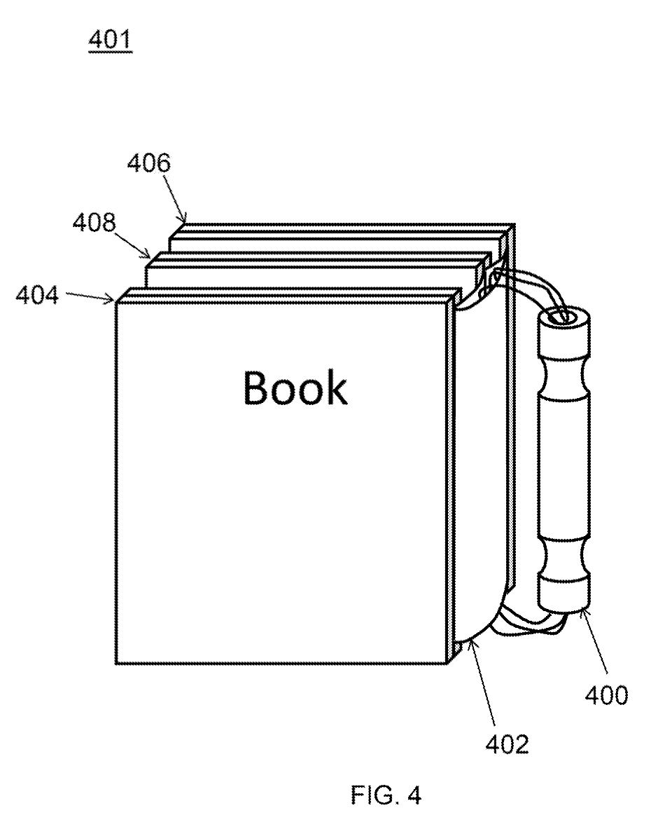

It should be understood that there are other suitable techniques for forming a handle mechanism 102 that is integrally connected with the binding 110. For example, FIG. 4 depicts another aspect of the book 401 in which the handle mechanism 400 is integrally connected with the binding 402. As was the case above, the book 401 includes a front cover 404, rear cover 406, and at least one page 408 therebetween. In this case, however, the binding 402 is not cord based and is formed through use of a sheet material.

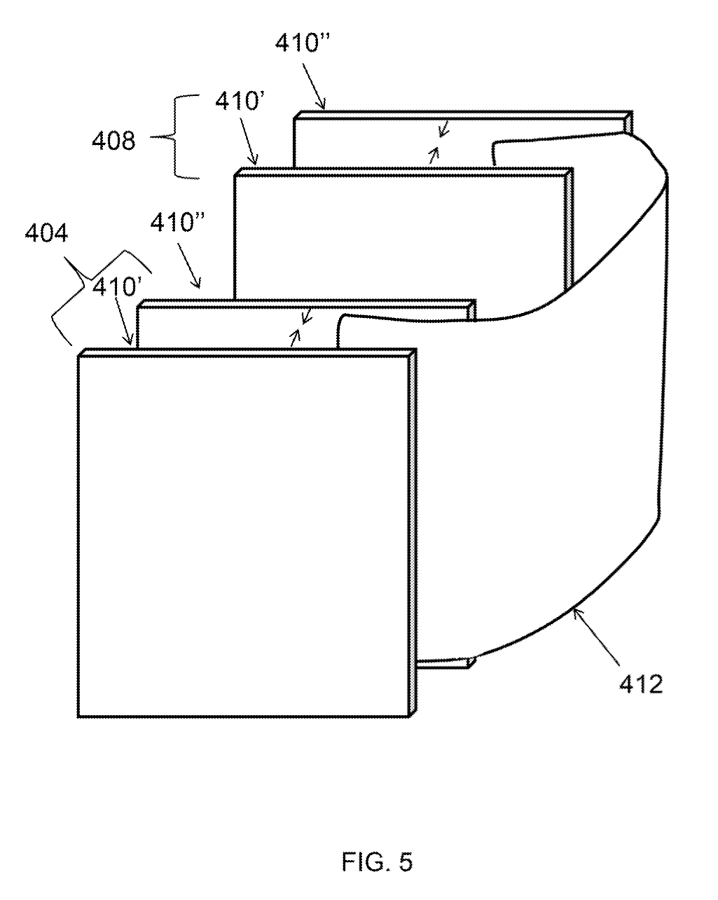

For further understanding, FIG. 5 depicts a process by which two adjacent leaves are attached with one another. For example, the front cover 404 is attached with an adjacent page 408 (or by which adjacent pages are attached with one another or with a rear cover). In this aspect, each page 408 is formed of two halves 410′ and 410″. For example, each half 410′ and 410″ is a wood leaf. Positioned between each half 410′ and 410″ is a sheet material 412. The sheet material 412 is any suitable material that is flexible yet durable enough to operate as a binding, non-limiting examples of which include cloth, paper, and plastic. In a desired aspect, the sheet material 412 is a cloth sheet.

It should be noted that although the terms “half” or “halves” is used, the terms are not intended to imply that the two components are equal in size. Instead, the terms are intended to mean that the two components (i.e., halves) are combined to create a complete leaf. Thus, one half 410′ can be equal to, thicker, thinner, bigger, or smaller, than the other half 410″.

Further, the sheet material 412 is positioned and affixed between the two halves 410′ and 410″. For example, each of the two halves 410′ and 410″ are glued together (with the sheet material 412 sandwiched and glued therebetween) to form the page 408. The sheet material 412 is similarly attached between the two halves of the front cover 404. Thus, the sheet material 412 effectively operates to bind the front cover 404 with the page 408. Although the invention is not limited thereto, each of the front cover 404 and rear cover (and any additional pages) can be bound to one another using similar technique.

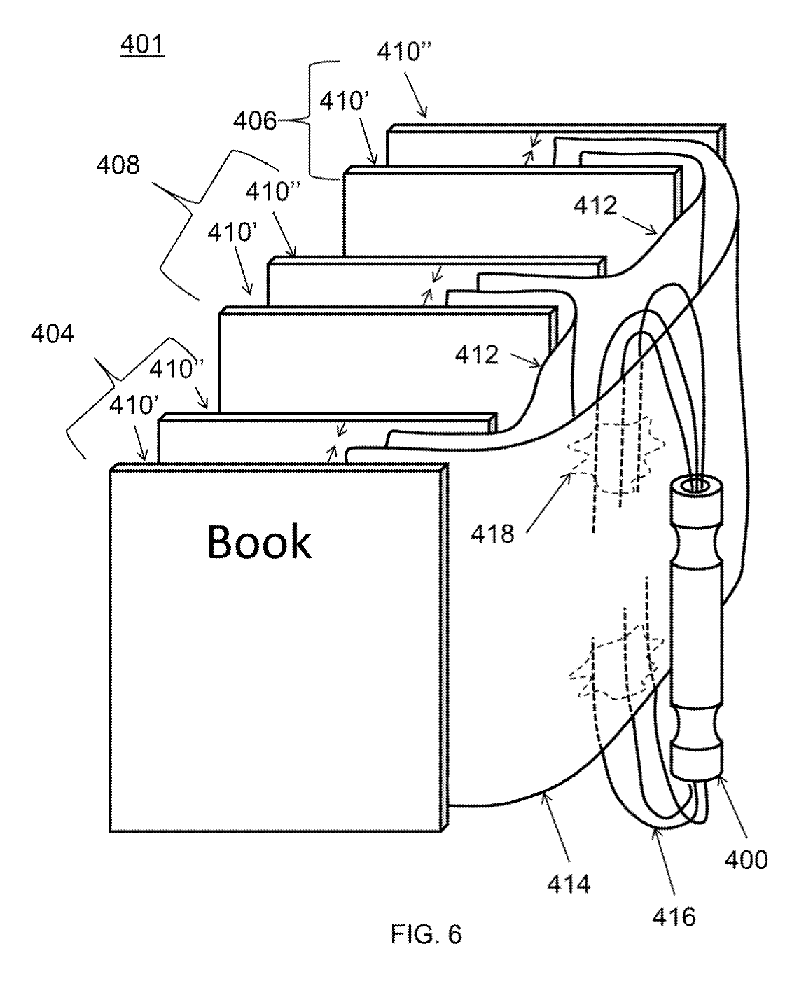

For example and as shown in FIG. 6, additional pieces of sheet material 412 can be used to attach adjacent pages (and/or covers). For example, each of the front cover 404, rear cover 406 and pages 408 are formed of two halves 410′ and 410″. Sandwiched between each of the respective to halves 410′ and 410″ is a sheet material 412 that is similar sandwiched between the two halves 410′ and 410″ of an adjacent page 408 or cover 404 and 406. This process binds each of the pages 408 and/or covers 404 and 406 to its immediately adjacent page 408 and/or cover 404 and 406. An outer sheet material 414 is sandwiched (e.g., glued) between the two halves 410′ and 410″ of each of the front cover 404 and rear cover 406. The outer sheet material 414 serves to complete the binding by covering each of the individual page bindings (e.g., such as the sheet material 412 between the front cover 404 and page 408) and attaching the front cover 404 with the rear cover 406.

Although the handle mechanism 400 can be formed using a cord and holes as depicted in FIGS. 1 through 4, FIG. 6 depicts an alternative aspect in which the handle mechanism 400 is affixed with the outer sheet material 414. In this case, the handle mechanism 400 includes at least one (or several as depicted) cord 416 that pass through the handle mechanism 404 and are attached with the outer sheet material 414. For example, the cord 416 (or cords) can be positioned and affixed with the binding in any suitable manner. As a non-limiting example and as depicted, each end of the cord 416 is glued 418 against an inner surface of the outer sheet material 414. Thus, in this aspect, the glue 418 and glued ends of the cord 416 are positioned within the binding for protection and durability.

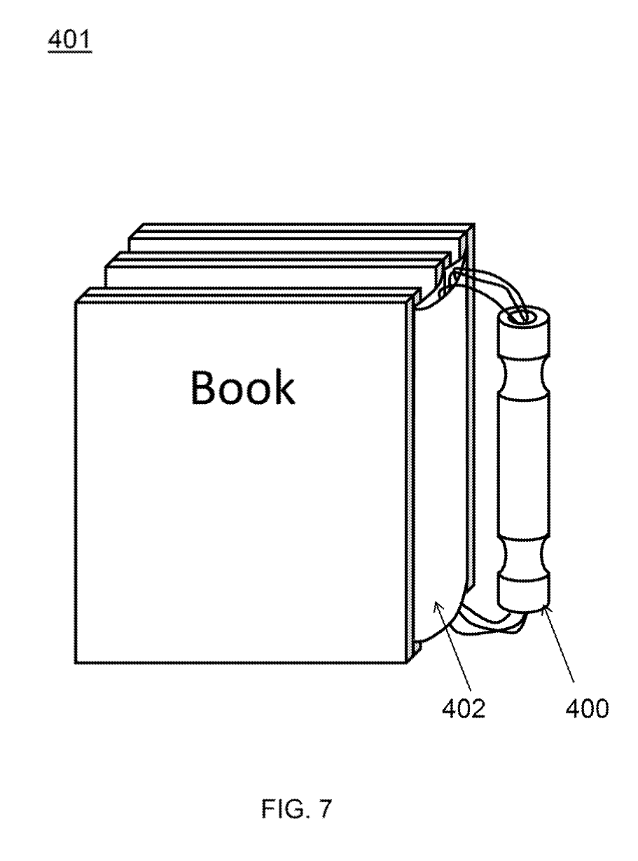

FIG. 7 depicts the book 401 with the binding 402 and handle mechanism 400 that were assembled as described above with respect to FIGS. 4 through 6. Thus, as shown, the handle mechanism 400 is an integral part of the binding 402.

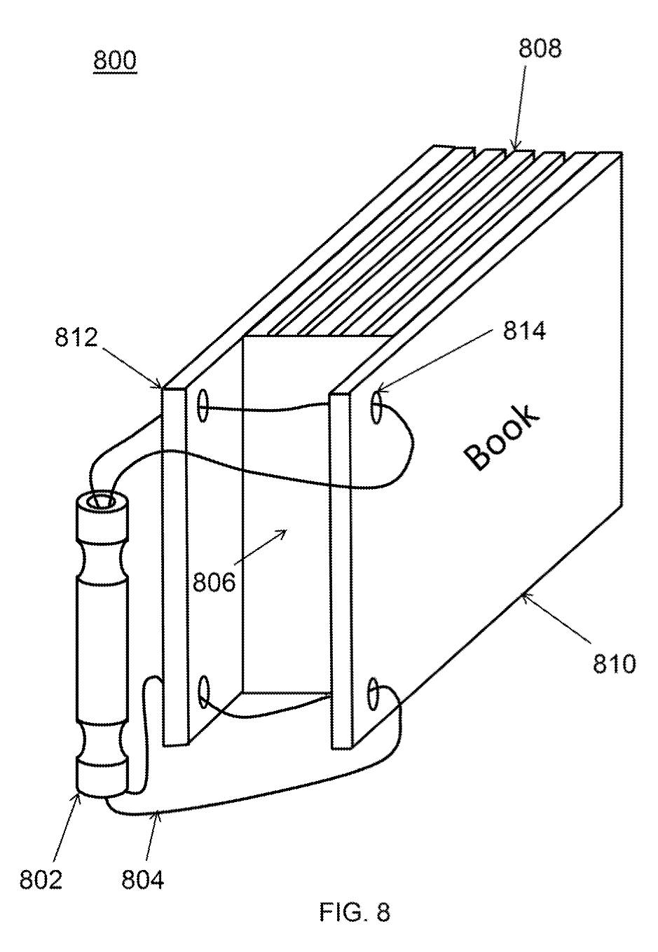

Another aspect of the book 800 is depicted in FIG. 8. In this aspect and as shown, the book binding functions separately from the handle mechanism 802 and its corresponding cord 804. For example, the book 800 is a board book with a traditional binding portion 806 that binds the pages 808. A front cover 810 and rear cover 812 (e.g., wooden leaves) can be adhered (e.g., glued) to the book 800. The front cover 810 and rear cover 812 extend beyond the other pages 808 in the spine (i.e., at the traditional binding portion 806) to include holes 814. The holes 814 allow the cord 804 to be threaded therethrough to affix the handle mechanism 802 with the binding of the book 800.

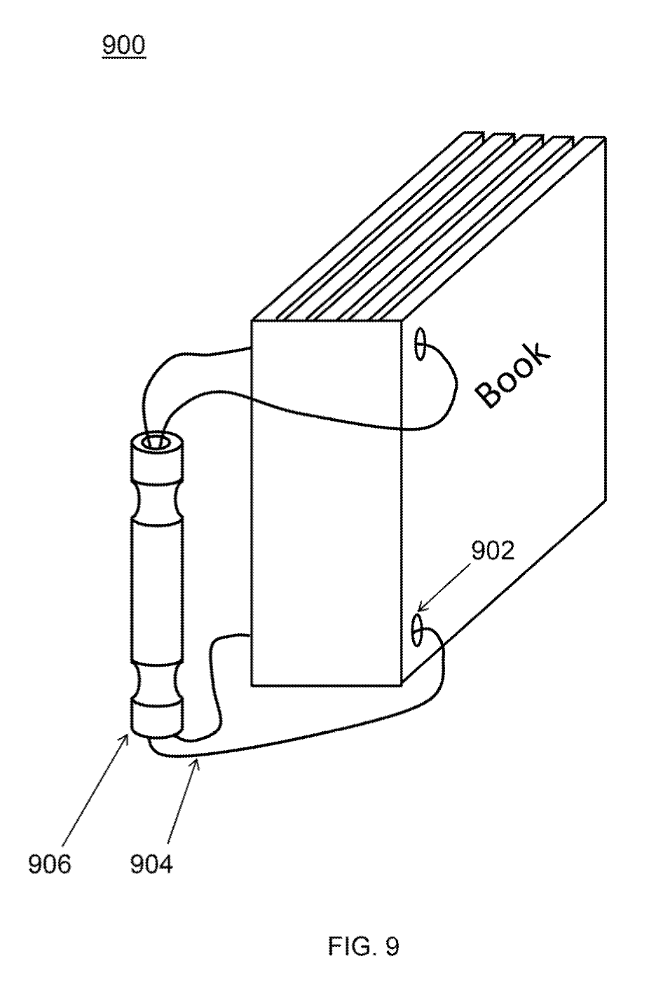

Yet another aspect is depicted in FIG. 9, which illustrates a board book 900 bound in a traditional binding format. Importantly, holes 902 are formed through each of the leaves (i.e., front cover, rear cover, and pages) of the book 900. The cord 904 is passed through the holes 902 to affix the handle mechanism 906 with the book 900 and further support the binding of the book 900.

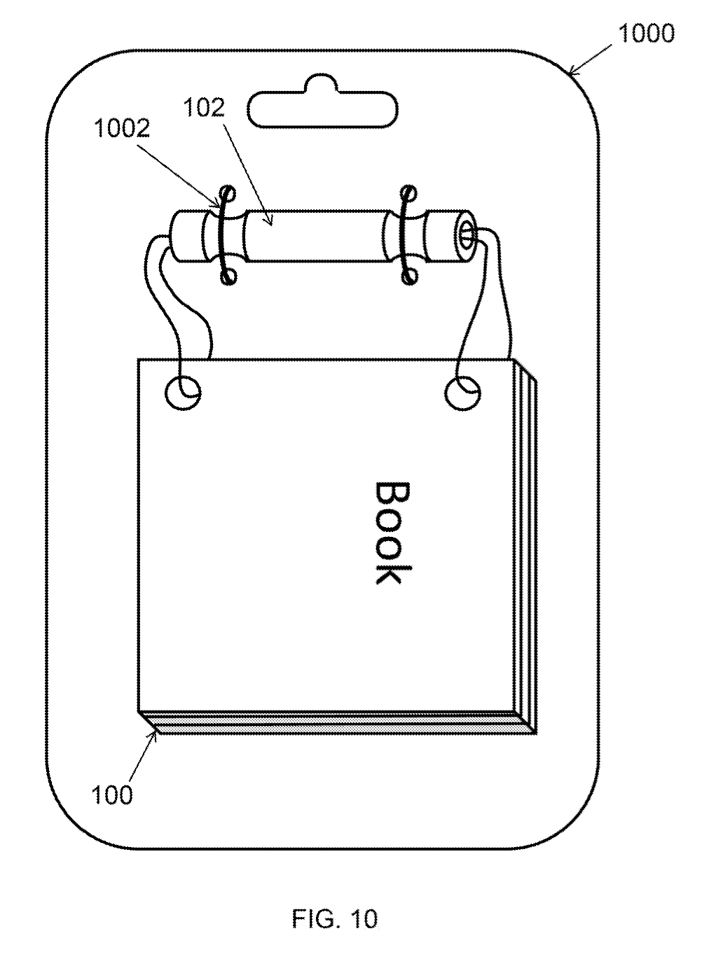

As depicted in FIG. 10, an added feature of the handle mechanism 102 is that it allows a book 100 according to the present invention to be easily attached to a display board 1000 by use of “ties” 1002. Non-limiting examples of ties 1002 are plastic or wire ties. For example, the plastic ties 1002 are wrapped around the handle mechanism 102 and through the display board 1000 to hold the book 100 against the display board 1000. It should be noted that although FIG. 10 depicts the book 100 and handle mechanism 102 as originally depicted in FIG. 1, the present invention is not intended to be limited thereto as any handle mechanism as understood by the present invention can be used to easily attached a book against the display board 1000.

What is claimed is:

1. A children's book, comprising:
at least two leaves;
a flexible device attached with the two leaves; and
a handle mechanism attached with the flexible device, thereby allowing a child to carry the children's book through use of the handle mechanism.

2. The children's book as set forth in claim 1, wherein the flexible device is a cord.

3. The children's book as set forth in claim 2, wherein each of the leaves has holes formed therethrough, with the cord passing through the holes to bind the leaves together and affix the handle mechanism with the book.

4. The children's book as set forth in claim 3, wherein the two leaves are a front cover and a rear cover, and further comprising a page positioned between the front cover and rear cover, with a hole formed through the pages such that the cord passes through the front cover, page, and rear cover to bind the book.

5. The children's book as set forth in claim 4, wherein the cord is threaded through each of the front cover, page, and rear cover to form a front cord loop and a rear cord loop, with the cord threaded through the handle mechanism to attach the front cord loop with the rear cord loop.

6. The children's book as set forth in claim 5, wherein the leaves are made of a material selected from a group consisting of wood, paperboard, and foam, or any combination thereof.

7. The children's book as set forth in claim 1, wherein each leaf is made of two halves, with a sheet material that is affixed between the two halves of each leaf to bind the leaves together.

8. The children's book as set forth in claim 1, wherein the two leaves are a front cover and a rear cover, and further comprising a page positioned between the front cover and rear cover, such that each of the front cover, rear cover, and page are made of two halves, with a sheet material that is affixed between the two halves of each leaf to bind the front cover to the page and the rear cover to the page, and wherein an outer sheet material is affixed between the two halves of each of the front cover and rear cover.

9. The children's book as set forth in claim 8, wherein the outer sheet material includes an inner surface, with the cord glued to an inner surface of the outer sheet material to affix the handle mechanism with the binding of the book.

10. The children's book as set forth in claim 1, further comprising a display board, with the handle mechanism affixed with the display board.
